(19) United States
(12) Patent Application Publication
(10) Pub. No.: US 2009/0208797 A1
(43) Pub. Date: Aug. 20, 2009

(54) Fuel cell stack humidification device

(75) Inventors: Hyun Yoo Kim, Gyeonggi-do (KR); Yong Sun Park, Gyeonggi-do (KR); Hyuck Roul Kwon, Gyeonggi-do (KR); Min Soo Kim, Seoul (KR); Jun Ho Song, Seoul (KR); Beom Jun Kim, Gwangju (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/218,124

(22) Filed: Jul. 11, 2008

(30) Foreign Application Priority Data
Feb. 14, 2008 (KR) 10-2008-0013413

(51) Int. Cl. H01M 8/04

(52) U.S. Cl. 429/26

(57) ABSTRACT

A fuel cell stack humidification device includes: an air flow field provided on a fuel cell separator and including an inlet portion and an outlet portion; and a water absorbing member mounted on both sides and the bottom of the air flow field to transfer water in the outlet portion to the inlet portion. The humidification device can provide an auxiliary humidification function and minimize the volume that a humidifier occupies in a fuel cell vehicle.

### CROSS-REFERENCE TO RELATED APPLICATION

This application claims under 35 U.S.C. §119(a) the benefit of Korean Patent Application No. 10-2008-0013413 filed Feb. 14, 2008, the entire contents of which are incorporated herein by reference.

### BACKGROUND

(a) Technical Field

The present invention relates to a fuel cell stack humidification device. More particularly, the present invention relates to a fuel cell stack humidification device including an air flow field mounted on a fuel cell separator and a water absorbing member provided on both sides and the bottom of an air flow field, which can provide an auxiliary humidification function to increase the humidity of an inlet portion of the air flow filed.

(b) Background Art

Typically, vehicles are driven by a fossil fueled engine. Carbon dioxide is produced and emitted as gas when fossil fuels are burned, which contributes to global warming. Numerous fossil fuel substitutes have been studied, and a hydrogen fuel cell has attracted much attention as a green energy source due to its high energy efficiency and low emission.

A fuel cell generates electricity and may be maintained as long as a fuel is supplied. Compared with an electric vehicle driven by electric power of a battery, a vehicle driven by the fuel cell has a much longer driving distance without having to take a long time for charging the battery.

The most attractive fuel cell for use of a vehicle is a polymer electrolyte membrane fuel cell (hereinafter referred to as a PEM fuel cell) having the highest power density among the fuel cells. The PEM fuel cell has a fast start-up time and a fast reaction time for power conversion due to its low operation temperature. However, the PEM fuel cell has problems in that it requires an expensive catalyst, causes catalyst poisoning, and has a difficulty in controlling water.

Here, the basic operation principle of the PEM fuel cell will be described with reference to the diagram of FIG. 1.

The reactant gas of the PEM fuel cell includes hydrogen and oxygen as shown in FIG. 1 and represented by the following formula 1:

2H₂+O₂→2H₂O [Formula 1]

In general, the fuel cell driven vehicle has a hydrogen tank only, and oxygen is supplied from the air. When pure oxygen is used, the output of the fuel cell is increased; however, since the volume of an oxygen tank is greater than that of the hydrogen tank, it is not economical to mount the oxygen tank together with the hydrogen tank in the vehicle.

As represented by formula 2 below, the hydrogen is ionized at an anode of the fuel cell to release an electron and become H⁺ ion.

2H₂→4H⁺+4e⁻ [Formula 2]

Moreover, as represented by formula 3 below, the hydrogen ion reacts with the oxygen at a cathode of the fuel cell to combine with the electron, thus generating steam.

O²+4H⁺+4e⁻→2H₂O [Formula 3]

Since the above reaction occurs at the cathode, as shown in FIG. 1, the hydrogen ion should pass through a PEM, and the membrane permeability of hydrogen is determined by a function of water content.

As the above reaction proceeds, water is produced to humidify the reactant gas and the membrane. If the gas is dried, the whole quantity of water produced by the reaction is used to humidify the air, and thus the polymer electrolyte membrane is dried.

Meanwhile, if the PEM is excessively wetted, pores of a gas diffusion layer (GDL) are clogged, and thus the reactant gas is not in contact with the catalyst.

Accordingly, it is very important to appropriately maintain the water content of the polymer electrolyte membrane. Accordingly.

Various methods of humidifying the PEM fuel cell have been proposed. For example, a gas-to-gas membrane humidifier is widely used as a conventional device for humidifying the PEM fuel cell. The operation principle of the gas-to-gas membrane humidifier will now be described with reference to FIG. 2.

As shown in FIG. 2, in the gas-to-gas membrane humidifier 40, fuel cell exhaust gas flows in one side surface 20 and supply gas flows in the other side surface 30 with an exchange membrane 10 disposed therebetween, through which water permeates. The gas supplied to the membrane humidifier is supplied with heat and water at the same time from the exhaust gas, which is heated and in a water saturated state as it is discharged from the fuel cell stack.

The gas-to-gas membrane humidifier has some advantages in that, since it is supplied with heat and water at the same time, it is possible to reduce the volume of the overall humidifier and to provide a relatively simple structure, compared with other external humidifiers having a separate heat exchanger.

However, the above membrane humidifier has some disadvantages in that the exchange membrane is expensive and the manufacturing cost is high. Moreover, since the gas passes through a narrow and long flow field, a high pressure-drop may occur, and thus the power consumption of a gas supply device is increased. Furthermore, there are problems in that the vehicle may be stopped on an uphill road since the humidification is insufficient in a high load region, and the membrane humidifier is hard to control the amount of humidification.

As a substitute for the membrane humidifier, an injection humidifier may be considered. The injection humidifier is to increase the humidification efficiency by injecting water to be atomized using an injector in order to increase the surface area for evaporation.

The humidification using the injector has advantages in that it is possible to employ an injection humidification technique that has been applied to other fields and the manufacturing cost is low.

However, the volume of the injection humidifier is increased in order to provide sufficient humidification and, since the above-described membrane humidifier and injection humidifier are all external humidifiers, they have a disadvantage in that it is difficult to apply any one of the humidifiers to a vehicle having a limited space.

There is thus a need for a humidifier to solve the above problems.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

In one aspect, the present invention provides a fuel cell stack humidification device, as an internal humidifier, comprising: an air flow field provided on a fuel cell separator and including an inlet portion and an outlet portion; and a water absorbing member mounted on both sides and the bottom of the air flow field to transfer water present in the outlet portion to the inlet portion.

In a preferred embodiment, the water absorbing member is formed in the shape of U.

In another preferred embodiment, the water absorbing member is formed of porous polyvinyl alcohol (PVA) sponge composed of a hydrophilic porous medium in which pores are connected to each other to increase capillary attraction.

In still another preferred embodiment, the water absorbing member comprises a transfer passage, through which only water moves, arranged so as not to overlap the air flow field.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above and other features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a diagram showing a basic structure of a fuel cell stack;

FIG. 2 is a schematic diagram of a conventional gas-to-gas membrane humidifier;

FIGS. 3A and 3B are schematic diagrams of a fuel cell stack humidification device in accordance with a preferred embodiment of the present invention;

FIG. 4 is a schematic diagram of an air flow field in accordance with the preferred embodiment of the present invention;

FIG. 5 is a schematic diagram showing the flow of air and water in the fuel cell stack humidification device in accordance with the present invention;

FIG. 6 is a schematic diagram showing the supply of water in the fuel cell stack humidification device in accordance with the present invention; and

FIGS. 7 and 8 are schematic diagrams showing an adjusting pipe of the fuel cell stack humidification device in accordance with the present invention.

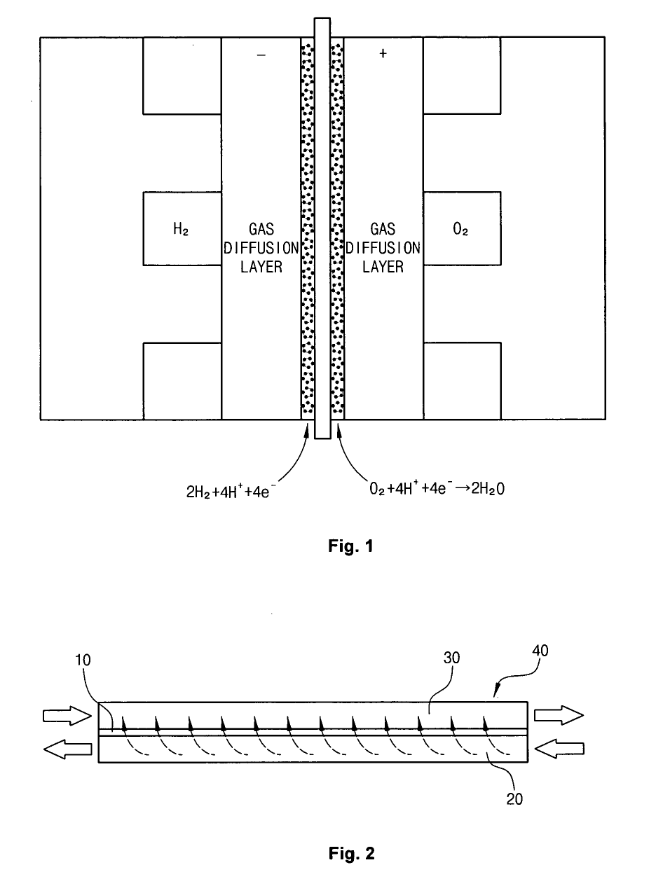

Reference numerals set forth in the Drawings includes reference to the following elements as further discussed below:

| | |
|---|---|
| 100: fuel cell separator | 110: air flow field |
| 120: inlet portion | 130: outlet portion |
| 200: water absorbing member | 300: humidification chamber |
| 310: inlet | 320: water supply passage |
| 330: coolant flow field | 350: adjusting pipe |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

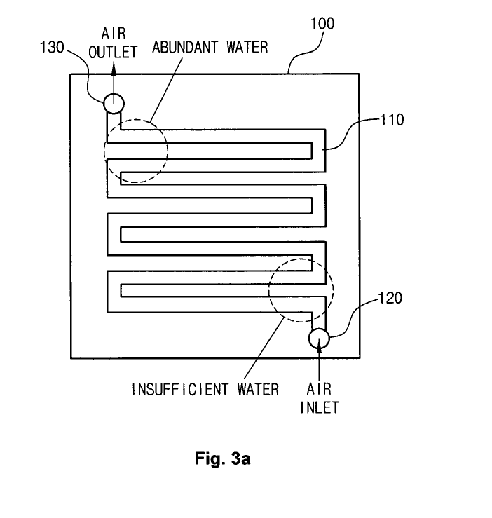

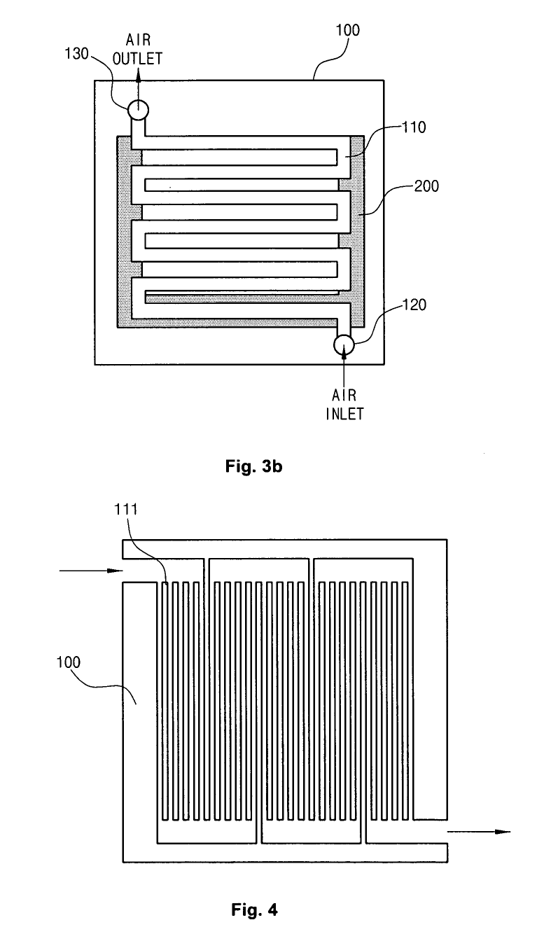

As shown in FIG. 3B, a fuel cell stack humidification device includes an air flow field 110 mounted on a fuel cell separator 100 and a water absorbing member 200 provided on both sides and the bottom of the air flow field 110. The water absorbing member 200 is formed of a porous material, which transfers water present in an outlet portion 130 of the air flow field 110 to an inlet portion 120 by capillary attraction and gravity, thus increasing the humidity of the inlet portion 120 and minimizing the volume that a humidifier occupies in a fuel cell vehicle.

In the outlet portion 130 in a PEM fuel cell, water generated by a reaction in the fuel cell is accumulated and the electrolyte membrane is sufficiently wet, and thus the necessity of artificial humidification in the outlet portion 130 is low.

On the other hand, the necessity of artificial humidification in the inlet portion 120 is relatively high. In particular, air having a temperature lower than the operation temperature of the fuel cell stack is introduced into the inlet portion 120 and, even though the introduced air has a relative humidity of 100%, the relative humidity is rapidly reduced when the temperature is increased. Since the evaporation rate of water is proportional to a difference between the saturated relative humidity of 100% and a relative humidity, the dryness of the electrolyte membrane in the inlet portion 120 is increased, thus necessitating artificial humidification to the inlet portion 120.

To this end, according to the present invention, the water absorbing member 200 is provided on the fuel cell separator 100 to transfer water in the outlet portion 130 to the inlet portion 120.

The air flow field 110 is a passage provided to supply air to an anode of the fuel cell separator 100. It includes the inlet portion 120, through which air is introduced, and the outlet portion 130, through which air is discharged.

Preferably, the air flow field 110 has a serpentine shape that is folded left and right repeatedly from the inlet portion 120 at the bottom of the fuel cell separator 100 to the outlet portion 130 at the top thereof. The serpentine-shaped air flow field 110 is formed with a single passage, differently from an air flow field having a parallel structure in which a plurality of flow fields are formed in parallel without being folded. Accordingly, when the air flow field 110 is clogged by water, the water may be removed by increasing the flow rate, and thus it is possible to maintain the reaction in a wide region.

Also preferably, the air flow field 110 may have a semi-serpentine shape 111, as shown in FIG. 4, in which a plurality of parallel passages are folded left and right repeatedly. The semi-serpentine-shaped air flow field 110 is preferred, for example, in a situation where the electric power required for supplying the reactant gas is increased due to an increase in pressure drop in the serpentine-shaped air flow field 110.

The water absorbing member 200 is attached to both sides and the bottom of the air flow field 110 and formed in the shape of U that surrounds the outer wall of the air flow field 110. With the use of the water absorbing member 200, the water in the outlet portion 130 is transferred to the inlet portion 120 to keep the water balance in the overall air flow field 110.

Preferably, the water absorbing member 200 is formed of a hydrophilic porous material that can transfer the water in the outlet portion 130 to the inlet portion 120 by capillary attraction and gravity. For example, the water absorbing member 200 may be formed of polyvinyl alcohol (PVA) sponge composed of a porous medium in which pores are connected to each other to increase the capillary attraction.

The PVA sponge is a porous material having a continuous open-cell structure formed of polyvinyl alcohol and exhibiting a peculiar three-dimensional continuous porous structure. The PVA sponge is hydrophilic and excellent in instantaneous water absorption capability and overall amount of water absorption, chemical resistance, abrasion resistance, softness, and elasticity.

The PVA sponge functions to increase capillary attraction of the water absorbing member 200 to the extent that it is sufficient to transfer the water overcoming the pressure drop in the air flow field 110.

When the PVA sponge having a thickness of 0.5 mm was compressed to a thickness of about 0.2 mm, the porosity and the pore size were 0.75 and 96 μm, respectively, and the capillary rise height was 19.5 cm. The capillary rise height corresponds to a capillary attraction of 1400 Pa, which is sufficient to overcome the pressure drop of air.

Like this, the air introduced through the inlet portion 120 of the air flow field 110 is supplied with water from the water absorbing member 200 while passing therethrough until it reaches the outlet portion 130.

As shown in FIG. 5, the water absorbing member 200 may, preferably, include a transfer passage 210, through which only water moves without the air resistance, and an inside passage 220 arranged to partially overlap the air flow field 110.

In this case, the transfer passage 210 is formed on the side surface of the air flow field 110 such that the resistance encountered by the air flow of the air flow field 110 is reduced while the water in the outlet portion 130 is transferred to the inlet portion 120.

As above, the direction that the water moves is opposite to the direction that the air flows from top to bottom and. Since the air flow rate in the air flow field 110 is about 6 m/s, the water absorbed to the water absorbing member 200 cannot flow against the air flow.

To this end, the transfer passage 210, through which the air does not flow but only water moves, is provided in the water absorbing member 200.

Furthermore, as shown in FIG. 5, since the transfer passage 210 of the water absorbing member 200 is in contact with a separator and a membrane electrode assembly (MEA) provided outside the air flow field 110, the air cannot flow in the transfer passage 210.

However, an inside passage 220 of the water absorbing member 200, provided to overlap the air flow field 110, absorbs water generated in the outlet portion 130 of the air flow field 110 and transfers the same to the transfer passage 210 of the water absorbing member 200, and the transferred water is moved to the inlet portion 120 of the air flow field 110 by capillary attraction and gravity.

Like this, the water absorbed from the outlet portion 130 of the air flow field 110 to the top of the water absorbing member 200 is moved to the bottom of the water absorbing member 200 to humidify the air in the inlet portion 120 of the air flow field 110. At this time, the water generated in the outlet portion 130 of the air flow field 110 may be insufficient. The present invention provides a means for overcoming such a problem.

Preferably, a means for preventing water from being evaporated by varying the operational conditions of the fuel cell stack humidification device may be provided. For instance, a high-performance blower may be provided to increase the relative humidity by increasing the pressure of the introduced air. Also preferably, a separate humidifier may be provided.

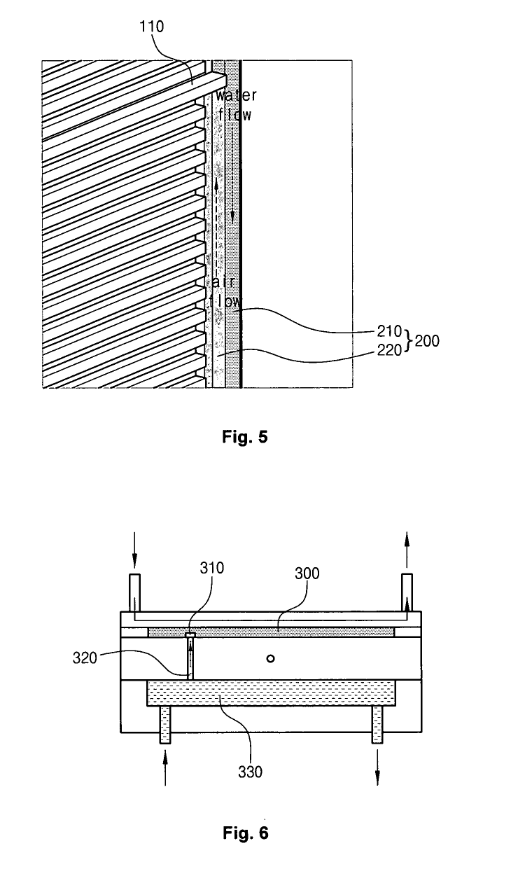

As another means, a humidification chamber 300 having a predetermined space is provided on the bottom of the air flow field 110 of the fuel cell separator 100, as shown in FIG. 6. An inlet 310 is provided on one side of the humidification chamber 300. The inlet 310 is connected to a coolant flow field 330 of the fuel cell separator 100 through a water supply passage 320 to supplement water from coolant when water is insufficient. In this case, a needle valve (not shown) may be provided in the water supply passage 320 to be closed and opened according to the water content in the humidification chamber 300. A metering pump (not shown) may be provided on one side of the coolant flow field 330 to provide a power source for supplying water to the humidification chamber 300.

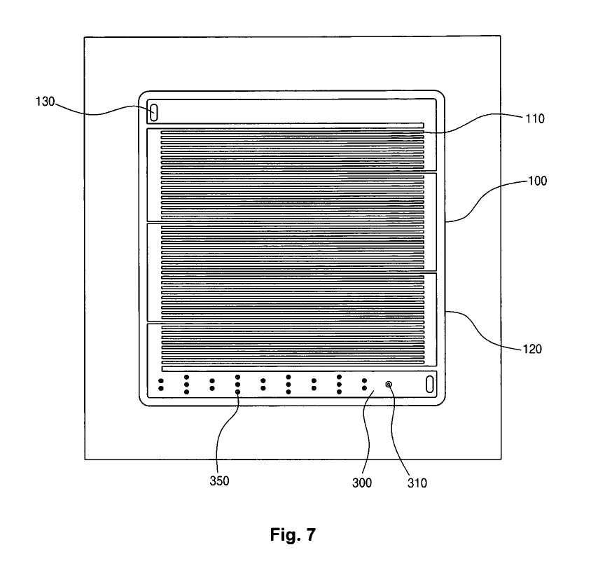

Meanwhile, as shown in FIG. 7, a plurality of adjusting pipes 350 are provided on one side of the humidification chamber 300 to prevent the air flow field 110 from being clogged due to liquid state moisture introduced from the humidification chamber 300 to the air flow field 110, and to provide a balanced water distribution in the water absorbing member 200. In this case, water flowing in one side of the humidification chamber 300 encounters the adjusting pipes 350, and thus it is not supplied to the air flow field 110 but absorbed to the water absorbing member 200 in the vicinity of the adjusting pipes 350.

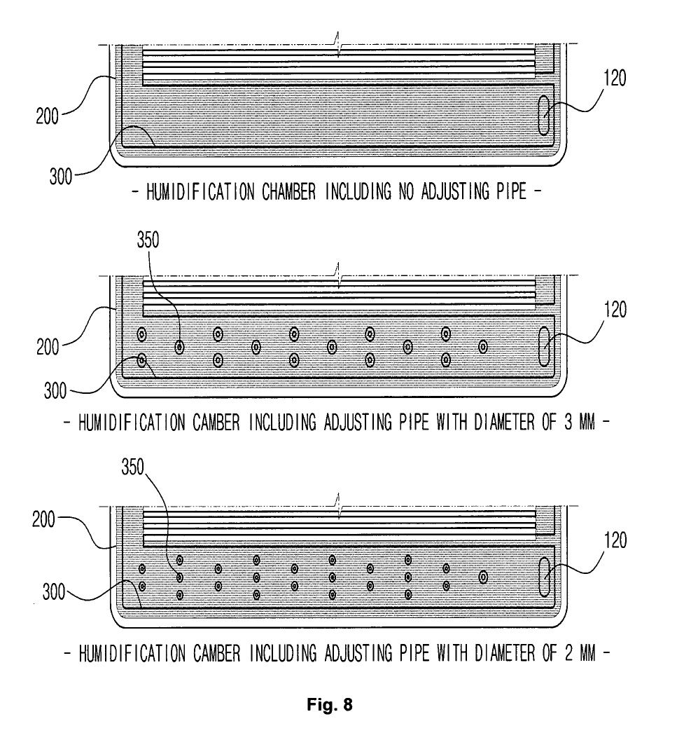

FIG. 8 shows a water absorbing member 200 without adjusting pipe 350, a water absorbing member 200 including adjusting pipes 350 having a diameter of 3 mm, and a water absorbing member 200 including adjusting pipes 350 having a diameter of 2 mm.

The water absorbing member 200 including the adjusting pipes 350 exhibited a more uniform water distribution than the water absorbing member 200 without adjusting pipe 350. The water absorbing member 200 including the adjusting pipes 350 having a diameter of 2 mm exhibited a more uniform water distribution than the water absorbing member 200 including the adjusting pipes 350 having a diameter of 3 mm. The water absorbing member 200 including the adjusting pipes 350 having a diameter of 2 mm exhibited a sufficient capillary attraction capable of overcoming the pressure drop of the adjusting pipes 350. Accordingly, it can be understood that the smaller the diameter of the adjusting pipes 350 provided in the water absorbing member 200, the more uniform the water distribution.

As described above, the fuel cell stack humidification device in accordance with the present invention provides the advantageous effects including the following. First, it provides artificial humidification to the air introduced into the air flow field. Moreover, it is possible to reduce the volume to be occupied by a humidifier and the electric power consumed by the humidifier. Furthermore, with the provision of the humidification chamber, it is possible to supplement insufficient water of the outlet portion of the air flow field.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A fuel cell stack humidification device comprising:
an air flow field provided on a fuel cell separator and including an inlet portion and an outlet portion; and
a water absorbing member mounted on both sides and the bottom of the air flow field to transfer water in the outlet portion to the inlet portion.

2. The fuel cell stack humidification device of claim 1, wherein the air flow field is in a serpentine shape that is folded left and right repeatedly from the inlet portion to the outlet portion.

3. The fuel cell stack humidification device of claim 1, wherein the air flow field has a semi-serpentine shape in which a plurality of parallel passages are folded left and right repeatedly.

4. The fuel cell stack humidification device of claim 1, wherein the water absorbing member is formed in the shape of U.

5. The fuel cell stack humidification device of claim 1, wherein the water absorbing member is formed of porous polyvinyl alcohol (PVA) sponge composed of a hydrophilic porous medium in which pores are connected to each other to increase capillary attraction.

6. The fuel cell stack humidification device of claim 5, wherein the PVA sponge has a thickness of about 0.5-0.2 mm.

7. The fuel cell stack humidification device of claim 1, wherein the PVA sponge has a thickness of about 0.2 mm.

8. The fuel cell stack humidification device of claim 1, wherein the air flow field is provided on the bottom thereof with a humidification chamber having a predetermined space.

9. The fuel cell stack humidification device of claim 8, wherein a plurality of adjusting pipes are provided on one side of the humidification chamber.

10. The fuel cell stack humidification device of claim 1, wherein the water absorbing member comprises a transfer passage, through which only water moves, arranged so as not to overlap the air flow field.
